(19) United States
(12) Patent Application Publication
(10) Pub. No.: US 2007/0126227 A1
(43) Pub. Date: Jun. 7, 2007

(54) NOTICE-IT

(75) Inventor: Joel Franklin Howard, Cleveland, TN (US)

Correspondence Address: JOEL FRANKLIN HOWARD, 2930 S. LEE HWY, # 12, CLEVELAND, TN, 37311, US

(73) Assignee: MR. JOEL FRANKLIN HOWARD, CLEVELAND, TN (US)

(21) Appl. No.: 11/164,478

(22) Filed: Nov. 23, 2005

(51) Int. Cl. B42D 15/00

(52) U.S. Cl. 283/81

(57) ABSTRACT

The applications are limitless and would have the possibility of use world-wide in the 33 languages as described above and potentially more. Some applications would include: For use on university and college dorm room doors, on books and articles of personal property and on projects left on desks. “NOTICE-IT” squares could even be left on food items in student refrigerators or cabinets, on anything left by the owner which is NOT TO BE DISTURBED. Use for every home or business office in the world to either place onto office doors quickly or upon work assembled on a desk, a computer station and all other office equipment or machinery that should not be disturbed. Use on home bedroom, study, and library doors by both children and adults. NOTICE-IT stickers could also be used throughout every home in the world on any object or door. To be placed on machinery or equipment that may be in the process of being serviced, repaired or altered, regardless of location. To be easily peeled-off and stuck to ANY surface on ANY object to warn all readers that whatever the object may be, it is NOT TO BE DISTURBED. It is my belief that NOTICE-IT stickers would sell incredibly well in ALL office supply stores, university/college bookstores, libraries, laboratories (whether government or private), stationery and art materials supply stores world-wide. It is my belief that having a stack of NOTICE-IT stickers would be so convenient that buyers in the above mentioned markets would make it a “must have” item. I have already purchased the domain name of NOTICE-IT.com

NOTICE-IT IDEA-INTELLECTUAL PROPERTY FOR ALL LANGUAGES OF THE WORLD. CONCEIVED BY JOEL FRANKLIN HOWARD ON AUG. 17, 2005. ALL RIGHTS RESERVED. JOELHOWARD@JOELHOWARD.COM 423.476.4019—HOME

NOTICE-IT stickers would be printed on a variety of colored papers on 3.5 to 4 inch squares with a light adhesive applied about a third of the way down the back of each peel-off and stick sized note. Each NOTICE-IT square could easily be pulled off the top of a stack of about 400-500 in each pack and attached to any object that the owner wishes NOT TO BE DISTURBED.

Each NOTICE-IT square of paper contains the following script in bold print in the 33 languages, herewith submitted, and potentially more. In all languages the following message:

PLEASE DO NOT DISTURB. THANKS.

English—Example

CONTINUING IN OTHER LANGUAGE TRANSLATIONS.
8) napaKaA) pnv EvoXAriaTE. EuXapICTiF-Russian
9) Commodo operor non perago. Gratiae. Latin
10) XapecBaM [symbol] ; He [symbol] [symbol] Bulgarian
11) Ugoditi ne opcina. hvala Croatian
12) Byt prijemny cinit ne pobourit. byt zavazan Czech
13) Behage lave ikke forstyrre. tak Danish
14) TrapaKaAki KUvw ⁶Xi 6IaTapaaCaw. EuXapia-Tr Greek
15) Legyen szives nem zavar. koszonet Hungarian
16) P6knast gera ekki trufla. takk Icelandic
17) [symbol] [symbol] Some characters not accepted. Japanese
18) Por favor hacer no turbar. gracias Latin Am. Spanish
19) masiyahan gumawa hindi abalahin. pasalamatan Filipino
20) Podobac sie czynic nie przeszkadzacr. dzieki Polish
21) prosim nikar ne motiti. hvala Slovenian
22) Behaga oroade inte. tack sjalv Swedish
23) Blesio gwna mo aflonydda. Thanks Welsh
24) [symbol] He [symbol] [symbol] [symbol] Russian
25) Haluta ajaa ei hairita. kiitoksia Finnish
26) Behage uroer ikke. takk Norwegian
27) A face pe plac la a face nu disturb. multumiri Romanian
28) Ugoditi ne smetati. zahvalnost Serbian
29) mutlu etmek yapmak degil rahatsiz etmek. tesekkur Turkish
30) Por favor fazer nao agitar. agradecimento Brazilian Portuguese
31) Characters were provided but not accepted Korean by the font provided/used.
32) Characters provided but not accepted by Chinese the font provided/used.
33) [symbol] Arabic

Intellectual Property Idea by Joel Franklin Howard. Conceived on Aug. 17, 2005. All rights reserved.* Contact JOELHOWARD@JOELHOWARD.COM or contact at home. 2930 S. Lee Hwy. #12 Cleveland, Tenn. 37311 423.476.4019 Home and Fax

[image]

[image]

[image]

What is claimed is:

1. Based upon my research, there is no other product that is like the one I've invented and described here—
NOTICE-IT stickers would be printed on a variety of colored papers on 3.5 to 4 inch squares with a light adhesive applied about a third of the way down the back of each peel-off and stick sized note. Each NOTICE-IT square could easily be pulled off the top of a stack of about 400-500 in each pack and attached to any object that the owner wishes NOT TO BE DISTURBED—
Each NOTICE-IT square of paper contains the following script in bold print in the 33 languages, herewith submitted, and potentially more. In all languages the following message:
PLEASE DO NOT DISTURB. THANKS.
